(19) United States
(12) Patent Application Publication
(10) Pub. No.: US 2018/0285702 A1
(43) Pub. Date: Oct. 4, 2018

(54) LANGUAGE MANAGEMENT CONTROL APPARATUS, IMAGE FORMING APPARATUS, AND NON-TRANSITORY COMPUTER READABLE MEDIUM

(71) Applicant: FUJI XEROX CO., LTD., Tokyo (JP)

(72) Inventors: Tomoaki HIRANO, Kanagawa (JP); Yusaku KURIHARA, Kanagawa (JP); Satoshi WATANABE, Kanagawa (JP); Masao YAMADA, Kanagawa (JP); Yuta YAMAGUCHI, Kanagawa (JP); Takahiko SUZUKI, Kanagawa (JP)

(73) Assignee: FUJI XEROX CO., LTD., Tokyo (JP)

(21) Appl. No.: 15/801,755

(22) Filed: Nov. 2, 2017

(30) Foreign Application Priority Data
Mar. 29, 2017 (JP) 2017-065904

(51) Int. Cl. G06K 15/02; G06F 3/12

(52) U.S. Cl. CPC G06K 15/1813; G06F 3/1284; G06F 3/1203; G06F 3/1248

(57) ABSTRACT

A language management control apparatus includes a first controller that issues an execute instruction to perform an image forming process by referencing received image information and by using a first language selected from among plural pre-stored languages, a memory that stores the received image information, and a second controller that, if the selected first language is determined to be inadequate after a start of an execution of the image forming process, performs an operation to issue a suspend instruction to suspend the image forming process, an operation to select a second language from plural languages by reading the image information from the memory, and an operation to issue the execute instruction to perform the image forming process.

### CROSS-REFERENCE TO RELATED APPLICATIONS

This application is based on and claims priority under 35 USC 119 from Japanese Patent Application No. 2017-065904 filed Mar. 29, 2017.

### BACKGROUND

### (i) Technical Field

The present invention relates to a language management control apparatus, an image forming apparatus, and a non-transitory computer readable medium.

### (ii) Related Art

Page description language (PDL) is a programming language that instructs an image forming apparatus to form (print) an image. In this specification, PDL is also referred to as an image forming processing language or a print language. The image forming apparatus stores and supports plural image forming processing languages.

The image forming apparatus may receive image forming job information (a job including image information). The image forming apparatus automatically determines an image forming processing language for image forming. If the image forming processing language for image forming is determined to be wrong, the image forming apparatus may request a job source to re-transmit the job.

### SUMMARY

According to an aspect of the invention, there is provided a language management control apparatus. The language management control apparatus includes a first controller that issues an execute instruction to perform an image forming process by referencing received image information and by using a first language selected from among plural pre-stored languages, a memory that stores the received image information, and a second controller that, if the selected first language is determined to be inadequate after a start of an execution of the image forming process, performs an operation to issue a suspend instruction to suspend the image forming process, an operation to select a second language from plural languages by reading the image information from the memory, and an operation to issue the execute instruction to perform the image forming process.

### BRIEF DESCRIPTION OF THE DRAWINGS

Exemplary embodiment of the present invention will be described in detail based on the following figures, wherein:

FIG. 1 schematically illustrates a communication network including an image processing apparatus in accordance with an exemplary embodiment;

FIG. 2 is a front view of the image processing apparatus of the exemplary embodiment;

FIG. 3 is a functional block diagram illustrating a control system of the image processing apparatus of the exemplary embodiment;

FIG. 4A through FIG. 4D are functional block diagrams of print language selection control that a controller in the image processing apparatus of the exemplary embodiment performs during a print job reception;

FIG. 5 schematically illustrates a procedure to select a print language from print data;

FIG. 6A through FIG. 6C illustrate a list of print languages supported by the image processing apparatus of the exemplary embodiment wherein FIG. 6A illustrates the list of all print languages, and FIG. 6B and FIG. 6C illustrate print languages that are correlated with each other; and

FIG. 7 is a flowchart illustrating a print job process control routine of the exemplary embodiment.

### DETAILED DESCRIPTION

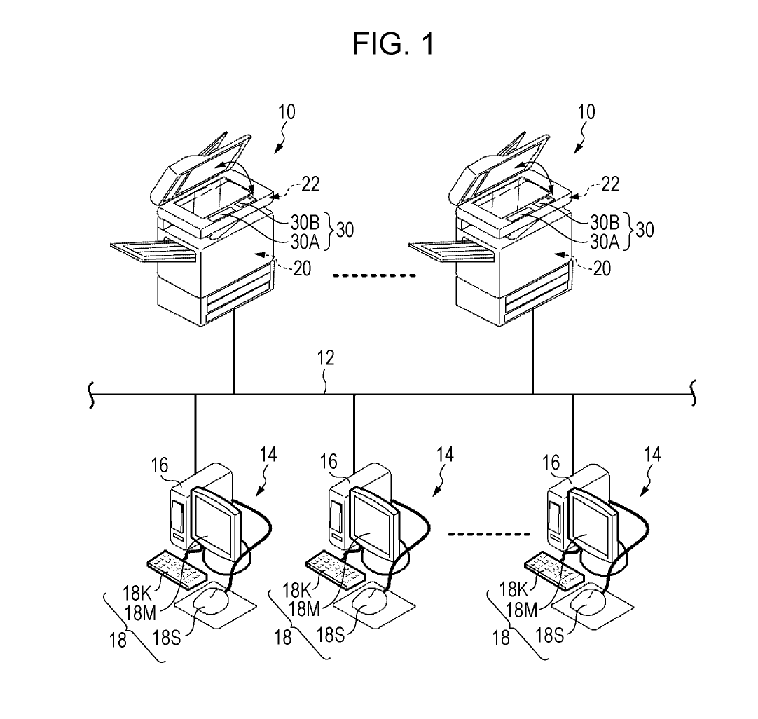

As illustrated in FIG. 1, an image processing apparatus 10 of an exemplary embodiment is connected to a communication network 12, such as the Internet. The communication network 12 includes a local-area network (LAN) and/or the Internet, or plural LANs mutually connected via a wide-area network (WAN). The communication network 12 may not necessarily have to be a wired network. The communication network 12 may be partly or wholly a radio communication network that receives and transmits information via radio communication.

FIG. 1 illustrates two image processing apparatuses 10. The number of image processing apparatuses 10 is not limited to two, but may be one or three or more.

The communication network 12 connects to plural personal computers (PCs) 14 as information terminal apparatuses. The PC 14 includes a body 16, and a user interface (UI) 18. The UI 18 includes a monitor 18M, and a keyboard 18K and a mouse 18S, serving as input operation units.

Referring to FIG. 1, three PCs 14 are connected to the communication network 12. The number of PCs 14 connected to the communication network 12 is not limited to three. One or two, or four or more PCs 14 may be used. The information terminal apparatus is not limited to the PC 14. The PC 14 may not necessarily be connected in a wired fashion. More specifically, a communication network transmitting and receiving information may be a radio communication network.

Referring to FIG. 1, the PC 14 may remotely control the image processing apparatus 10 by transmitting data for an image forming (print) operation (by transmitting a print job) to the image processing apparatus 10. A user may stand in front of the image processing apparatus 10, and instructs the image processing apparatus 10 to perform a variety of operations, including a copy operation, scan (image reading) operation, and facsimile transmission and reception operation.

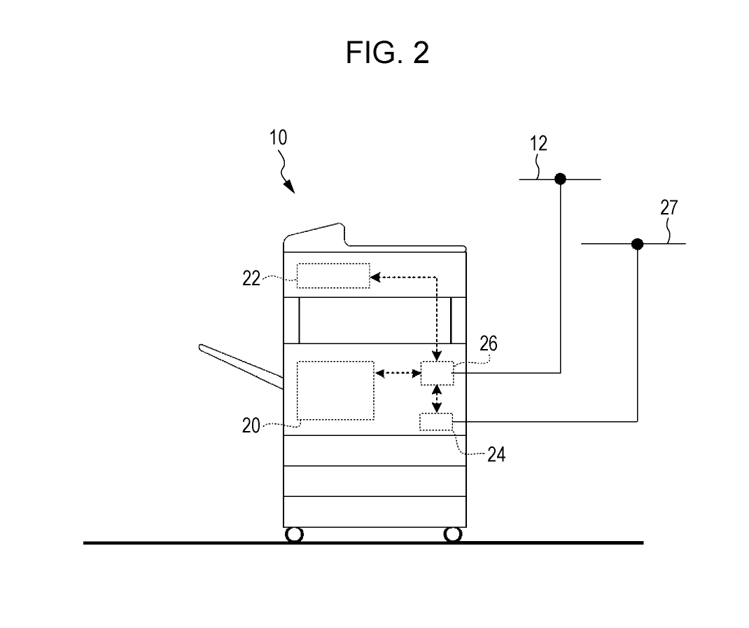

FIG. 2 illustrates the image processing apparatus 10 of the exemplary embodiment. The image processing apparatus 10 includes an image forming unit 20 that forms an image on a recording paper sheet, an image reading unit 22 that reads a document image, and a facsimile communication controller 24.

The image reading unit 22 includes a document platen on which an original document is placed, a scan driving system that emits a light beam to the original document while scanning the image of the original document placed on the document platen, and a photoelectric conversion device, such as a charge-coupled device (CCD), which receives light that is reflected from or passes through the original document while the scan driving system scans the original document, and which converts the received light into an electrical signal.

The image forming unit 20 includes a photoconductor drum. The image forming unit 20 also includes, around the photoconductor drum, a charging device that uniformly charges the photoconductor drum, a light exposure device that causes a light beam to scan across the photoconductor drum in response to image data, a development device that develops an image from an electrostatic latent image that has been formed by the light exposure device, a transfer device that transfers the image developed on the photoconductor drum to a recording paper sheet, and a cleaning device that cleans the surface of the photoconductor drum after the transfer. The image forming unit 20 also includes in a transportation path of the recording paper sheet a fixing device that fixes the image onto the recording paper sheet after the transfer.

The image processing apparatus 10 includes a controller 26. The controller 26 controls the image forming unit 20, the image reading unit 22, and the facsimile communication controller 24. The controller 26 temporarily stores image data of the image of an original document read by the image reading unit 22, and transmits the read image data to the image forming unit 20, the facsimile communication controller 24, or the PC 14.

The controller 26 is connected to the communication network 12, and the facsimile communication controller 24 is connected to a telephone line 27. The controller 26 is connected to the PC 14 (including a server or a host computer) via the communication network 12. The controller 26 has functionalities of receiving a print job (including image information), and of performing facsimile reception and facsimile transmission via the telephone line 27 using the facsimile communication controller 24.

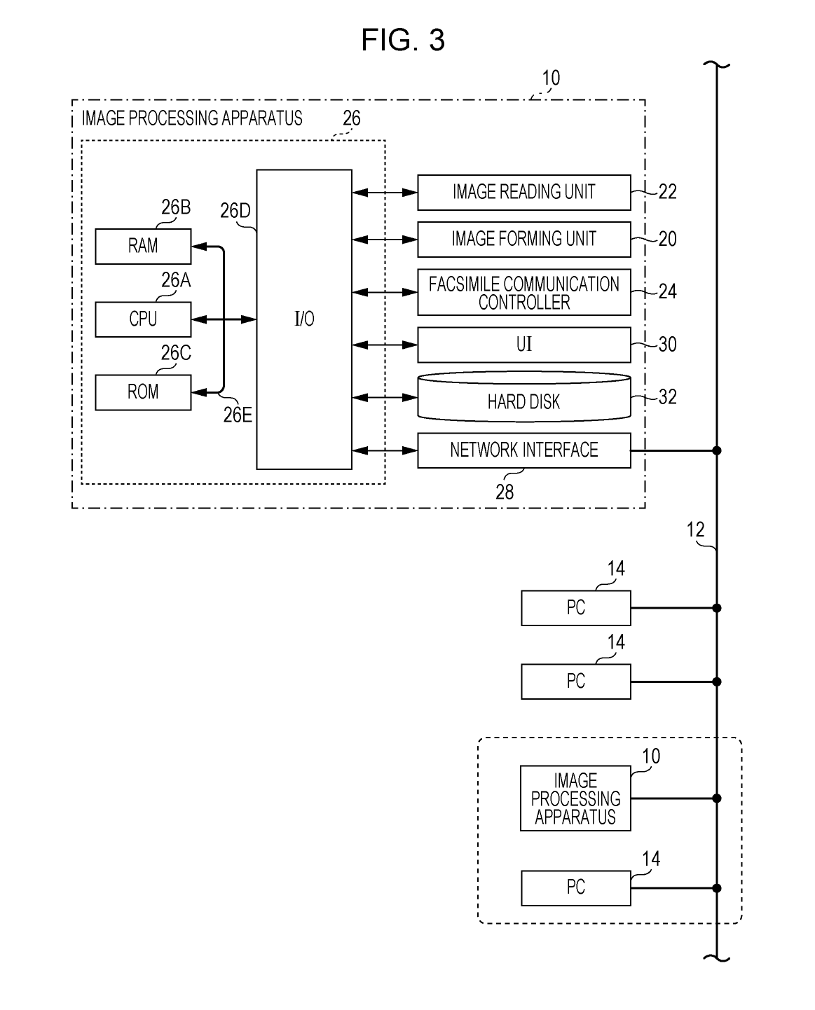

FIG. 3 is a functional block diagram illustrating a control system including the controller 26 of the image processing apparatus 10.

Referring to FIG. 3, the controller 26 in the image processing apparatus 10 includes a central processing unit (CPU) 26A, a random-access memory (RAM) 26B, a read-only memory (ROM) 26C, an input and output (I/O) unit 26D, and a bus 26E that interconnects these elements. The bus 26E includes a data bus and a control bus.

The I/O unit 26D connects to a network interface 28 configured to be connected to the communication network 12, and a user interface (UI) 30 (such as a touchpanel 30A and a hardware key 30B mounted on the top front portion of the casing of the image processing apparatus 10 as illustrated in FIG. 1).

The I/O unit 26D is connected to the image reading unit 22, the image forming unit 20, and the facsimile communication controller 24.

The controller 26 is also connected to a hard disk 32 as a large-scale recording medium. The hard disk 32 temporarily stores the print job (including the image information) received from the PC 14 or the like, the image information read by the image reading unit 22, and image information received by the facsimile communication controller 24.

Upon receiving a print job, the controller 26 in the image processing apparatus 10 of the exemplary embodiment determines a print language according to which the image forming unit 20 forms an image in response to image information included in the print job.

The hard disk 32 stores plural print languages (image forming processing languages), and supports image information generated in accordance with the print languages.

Upon receiving image forming job information (print job), the controller 26 in the image processing apparatus 10 analyzes the image information, and selects a print language from the plural print languages (print language selection function).

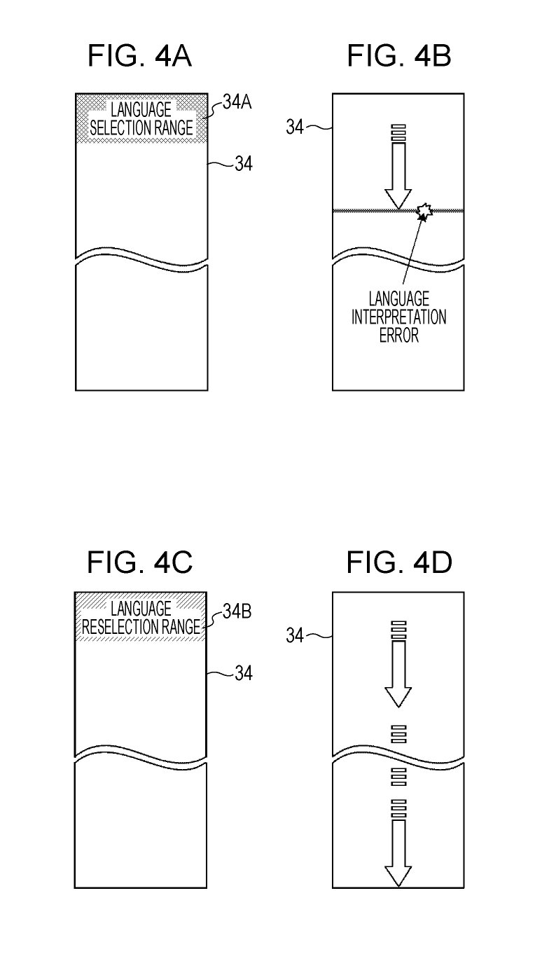

In view of convenience (fast process), the controller 26 analyzes print data 34 within the language selection range 34A (see FIG. 4A) rather than analyzing all the image information. The language selection range 34A is a top portion of the image information (for example, part or whole of the top portion).

When a print language is selected, the controller 26 instructs the image forming unit 20 to perform an image forming process. In response, the image forming unit 20 reads the selected print language, and starts image forming in response to the image information.

Since the analysis in the selection of the print language is performed within the language selection range 34A (see FIG. 4A) to achieve convenience (fast process), plural candidates may be selected. Among the print languages supported, similar print languages are present. A selected print language may suffer from a language interpretation error (see FIG. 4B). In other words, there is a possibility that an adequate print language is not uniquely determined in the print language selection within the language selection range 34A.

For this reason, after the beginning of the image forming process of the image forming unit 20, the controller 26 still continues the print language selection function to determine whether the selected print language is adequate. The controller 26 thus monitors the occurrence of a language interpretation error in all the image information.

In one comparison example, the occurrence of a language interpretation error may be detected in the print language during the image forming process, and a user who manages a transmission source of the print job is forced to cancel the image forming process, re-select a print language, and instruct the image forming process to be performed by re-transmitting the print job.

In yet another comparison example, the occurrence of a language interpretation error may be detected in the print language when an image recorded on a recording paper sheet is verified after the image forming process. A user who manages a transmission source of the print job is forced to re-select a print language, and instruct the image forming process to be performed by re-transmitting the print job.

In accordance with the exemplary embodiment in contrast to those examples, the following operations are performed after a print language responsive to a received print job is selected, and the image forming unit 20 is instructed to perform the image forming process.

### First Operation

A received print job is temporarily stored on the hard disk 32.

### Second Operation

The occurrence of a language interpretation error is monitored on the selected print language during the image forming process. The image forming process is performed based on bit-mat image forming data as a result of conversion by the selected print language.

### Third Operation

The image forming process is canceled if the occurrence of a language interpretation error is detected.

### Fourth Operation

The print job temporarily stored on the hard disk 32 is read, and a print language is re-selected from within a language selection range 34B (see FIG. 4C).

In the context of the exemplary embodiment, the word “re-select” is not limited to the second selection when a language interpretation error occurs in the first selection. The word “re-select” is applied to an (n+1)-th selection that is performed when a language interpretation error occurs in an n-th selection (n is a positive integer).

When the controller 26 performs the first through fourth operations, the image forming process is enabled to continue without requesting the user (such as the PC 14 serving as a print job transmission source) to re-transmit the print job.

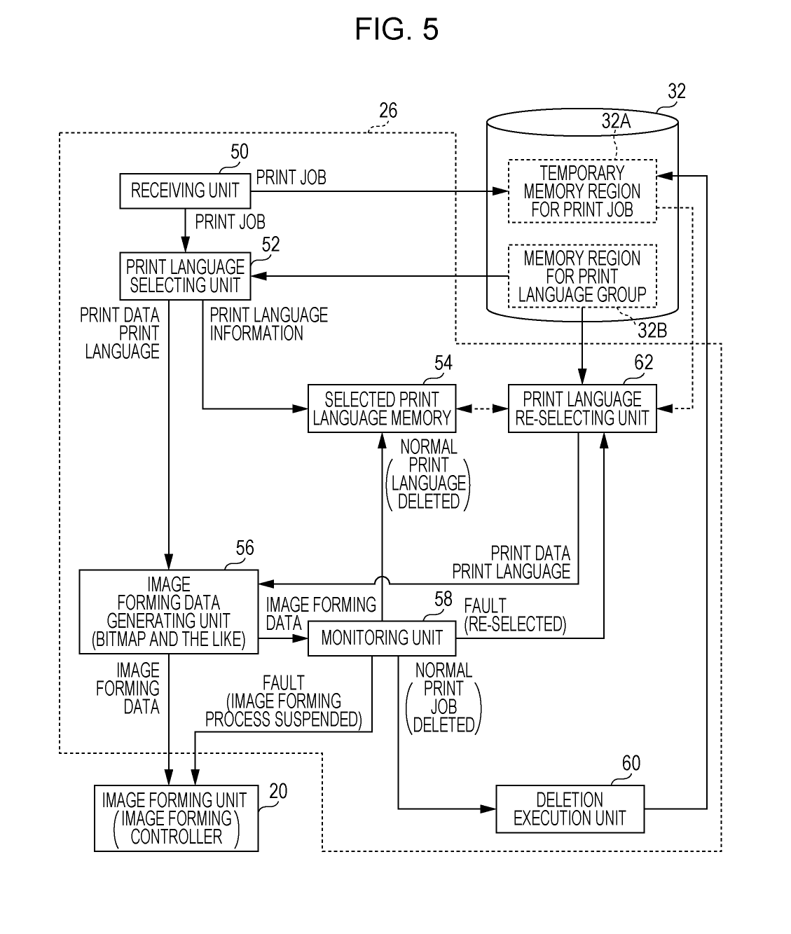

FIG. 5 is a control block diagram that illustrates, on a function-by-function basis, a management control process of image forming language of the controller 26. The management control process includes the first through fourth operations. Each block has the function thereof, and is not limited to the hardware structure of the controller 26. More specifically, some or all functions may be implemented using a software program.

A print job received by the receiving unit 50 is temporarily stored on a print job temporary memory region 32A on the hard disk 32 serving as an example of a memory. The print job is also transmitted to a print language selecting unit 52 that is an example of a first controller.

The print language selecting unit 52 reads print language information from a print language group memory region 32B on the hard disk 32, and selects a print language by referencing the language selection range of the print data as illustrated in FIG. 4A.

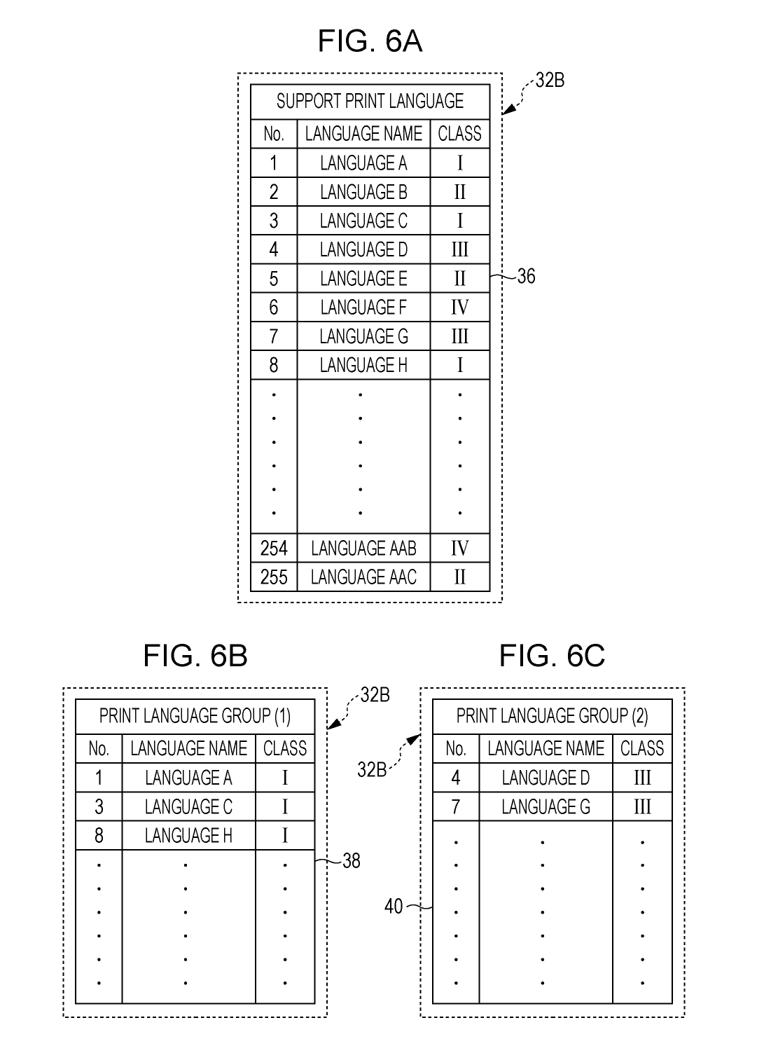

As illustrated in FIG. 6A, the print language group memory region 32B stores print language groups 36 including plural print language groups supported by the image processing apparatus 10.

In accordance with the exemplary embodiment, all the print languages supported are classified in print language groups (print language groups 38 and 40) as illustrated in FIG. 6B and FIG. 6C. In the print language re-selection, one print language is selected replacing another print language as long as those two print languages belong to the same group and are interchangeable with each other.

For example, if a print language selected by the print language selecting unit 52 belongs to the print language group 38 of FIG. 6B, another print language is selected in the re-selection from the print language group 38 of FIG. 6B as well.

The print language groups divided according to class are not limited to those listed in FIG. 6B and FIG. 6C. Depending on a variety of factors, a single print language may be registered across plural groups.

The print language selecting unit 52 is connected to a selected print language memory 54 and an image forming data generating unit 56 that is an example of the first controller or second controller.

The selected print language memory 54 receives print language information from the print language selecting unit 52. The selected print language memory 54 stores the received print language information.

The image forming data generating unit 56 receives print data from the print language selecting unit 52. Upon receiving the print data, the image forming data generating unit 56 generates image forming data in a format (such as bitmap) supporting image forming of the image forming unit 20, and outputs the image forming data to the image forming unit 20.

The image forming unit 20 performs the image forming process in response to the image forming data.

The image forming data generating unit 56 is connected to a monitoring unit 58 and outputs the image forming data to the monitoring unit 58. In parallel with the image forming of the image forming unit 20, the image forming data generating unit 56 monitors the presence or absence of a language interpretation error.

While the image forming process is in progress on the print language selected within the language selection range 34A of FIG. 4A, a language interpretation error may possibly occur as illustrated in FIG. 4B.

The monitoring unit 58 successively monitors the image forming data from beginning to end. If no language interpretation error occurs until the end, the monitoring unit 58 outputs normal end information to a deletion execution unit 60.

In response to the reception of the normal end information, the deletion execution unit 60 accesses the print job temporary memory region 32A on the hard disk 32 to delete the temporarily stored print job.

If a language interpretation error occurs with the monitoring unit 58 in operation, the monitoring unit 58 outputs fault information to the image forming unit 20 and a print language re-selecting unit 62 that is an example of the second controller.

Upon receiving the fault information, the image forming unit 20 suspends the image forming process.

Upon receiving the fault information, the print language re-selecting unit 62 selects a print language.

The print language re-selecting unit 62 is connected to the selected print language memory 54. In the print language re-selection operation, the print language re-selecting unit 62 reads the print language re-selected by the print language selecting unit 52. The print language re-selecting unit 62 accesses the print job temporary memory region 32A on the hard disk 32, thereby reading a temporarily stored pint job (in progress from FIG. 4B to FIG. 4C).

In accordance with the exemplary embodiment, the print job is re-selected without requesting the print job transmission source to re-transmit the print job.

The print language re-selecting unit 62 selects a print language from a print language group (see FIG. 4B or FIG. 4C) to which the previously selected print language belongs. Instead of the arbitrary re-selection, a print language is re-selected from a print language group including correlated print languages (see FIG. 6C).

The print language re-selected by the print language re-selecting unit 62 is cumulatively stored on the selected print language memory 54. The cumulative storage means that selected print languages are collected and stored. For example, if a language interpretation error occurs again after the re-selection, the re-selection is repeated. Each time the re-selection is performed, the selected print language is stored on the selected print language memory 54, increasing the number of stored print languages.

The print language re-selecting unit 62 is connected to the image forming data generating unit 56, and outputs the re-selected print language and the print data to the image forming data generating unit 56. The image forming data generating unit 56 performs the image forming process (see FIG. 4D).

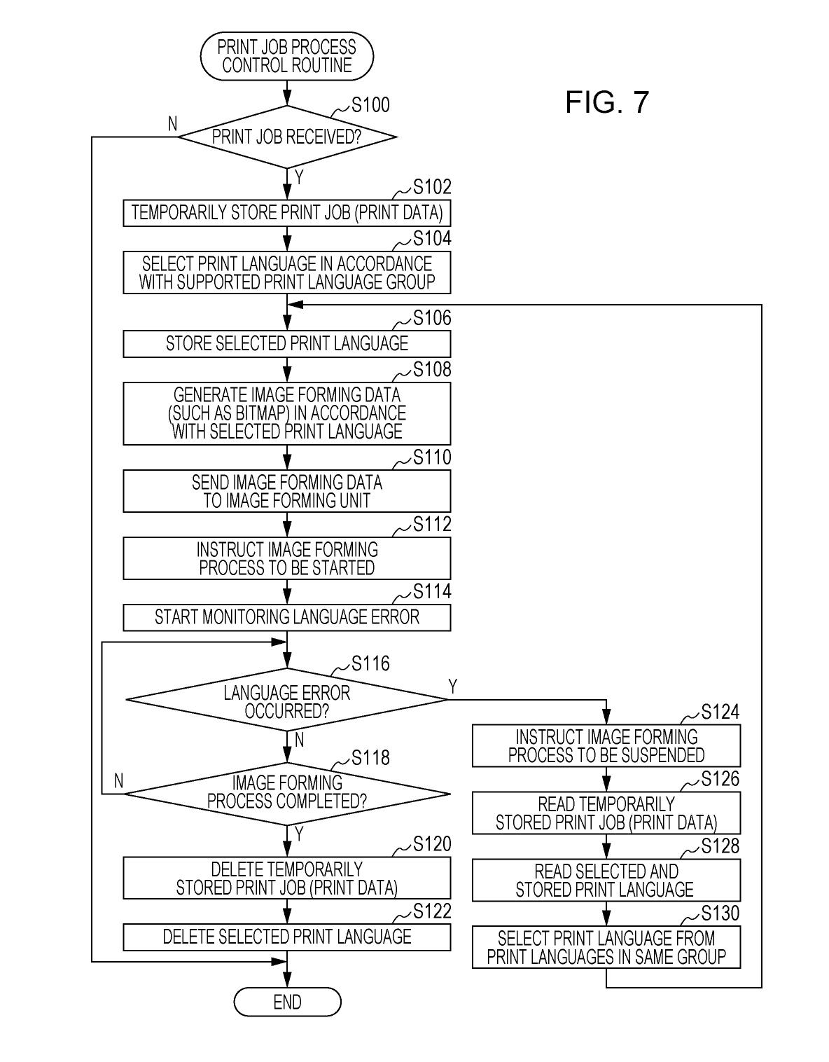

The process of the exemplary embodiment is described with reference to a flowchart of FIG. 7.

FIG. 7 illustrates a print job process control routine of the exemplary embodiment.

It is determined in step S100 whether a print job has been received. If the determination in step S100 branches to “no” branch, this routine ends. If the determination in step S100 branches to “yes” branch, processing proceeds to step S102. The print job (print data) is temporarily stored on the print job temporary memory region 32A on the hard disk 32, and processing proceeds to step S104.

In step S104, a print language is selected from a print language group supported (see FIG. 6A). Processing proceeds to step S106. The selected print language is stored on the selected print language memory 54.

In step S108, image forming data (such as bitmap data) is generated based on the selected print language. Processing proceeds to step S110. The image forming data is sent to the image forming unit 20. Processing proceeds to step S112.

In step S112, the image forming process is started. Processing proceeds to step S114. Any language interpretation error is monitored. Monitoring a language interpretation error is performed in parallel with the image forming process.

It is determined in step S116 whether any language interpretation error has occurred. If the determination in step S116 branches to “no” branch, processing proceeds to step S118 to determine whether the image forming process has been complete.

If the determination in step S118 branches to “no” branch, it is determined that the image forming process is in progress. Processing returns to step S116. The operations in steps S116 and S118 are repeated until the determination in step S116 or S118 branches to “yes” branch.

If the determination in step S118 branches to “yes” branch, in other words, the image forming process has been completed normally, processing proceeds to step S120. The print job (print data) temporarily stored on the print job temporary memory region 32A is deleted. Processing proceeds to step S122. The selected print languages cumulatively stored on the selected print language memory 54 are deleted. The routine thus ends.

If the determination in step S116 branches to “yes” branch, it is determined that a language interpretation error (fault) has occurred during the image forming process. Processing proceeds to step S124. The image forming process is instructed to be suspended. Processing proceeds to step S126.

In step S126, the print job (print data) temporarily stored on the print job temporary memory region 32A is read. Processing proceeds to step S128. The selected print language cumulatively stored on the selected print language memory 54 is read. Processing proceeds to step S130.

In step S130, a new print language is selected from the same print language group to which the selected print language belongs (such as those illustrated in FIG. 4B or FIG. 4C). Processing returns to step S106. The sub-routine starting with step S106 is repeated. In other words, if a language interpretation error occurs again on a re-selected print language, the re-selection of print language is repeated. In response to this iteration, the selected and re-selected print languages are cumulatively stored on the selected print language memory 54.

The image forming process that has been performed on the re-selected print language may now be normally ended (“yes” branch in the determination in step S118). In such a case, even if a language interpretation error occurs, an adequate image forming process is then performed without requesting the transmission source of the print job to re-transmit the print job. This lightens the workload on the transmitter side and receiver side (transmission and reception process of information).

The setting as to whether the image forming process is to re-start at the beginning thereof or on a page immediately preceding a page where the language interpretation error has occurred is desirably set in advance. This setting may be designed to be modified as appropriate.

A setting defining an operation to be performed subsequent to the occurrence of a language interpretation error may be modified as appropriate. For example, in one setting, the image forming process is set to quit if the number of language interpretation errors reaches a predetermined value. Also in another setting, the image forming process may be set to continue to the end thereof on a first print language even if the number of language interpretation errors reaches the predetermined value.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A language management control apparatus comprising:
a first controller that issues an execute instruction to perform an image forming process by referencing received image information and by using a first language selected from among a plurality of pre-stored languages;
a memory that stores the received image information; and
a second controller that, if the selected first language is determined to be inadequate after a start of an execution of the image forming process, performs an operation to issue a suspend instruction to suspend the image forming process, an operation to select a second language from a plurality of languages by reading the image information from the memory, and an operation to issue the execute instruction to perform the image forming process.

2. The language management control apparatus according to claim 1, wherein the second controller repeats the operations thereof until the first controller completes the image forming process.

3. The language management control apparatus according to claim 1, wherein the selected first and second languages are cumulatively stored until the image forming process has been completed in accordance with the image information.

4. The language management control apparatus according to claim 2, wherein the selected first and second languages are cumulatively stored until the image forming process has been completed in accordance with the image information.

5. The language management control apparatus according to claim 1, wherein the languages include a group of languages in a relationship that permits one of the languages in the group to be interchanged with another in the group.

6. The language management control apparatus according to claim 2, wherein the languages include a group of languages in a relationship that permits one of the languages in the group to be interchanged with another in the group.

7. The language management control apparatus according to claim 3, wherein the languages include a group of languages in a relationship that permits one of the languages in the group to be interchanged with another in the group.

8. The language management control apparatus according to claim 4, wherein the languages include a group of languages in a relationship that permits one of the languages in the group to be interchanged with another in the group.

9. The language management control apparatus according to claim 1, wherein the second controller selectively sets in advance the execute instruction to perform the image forming process using the selected second language in a manner such that the image forming process starts from a beginning thereof or at a point thereof where the selected first language is determined to be inadequate after the image forming process is suspended.

10. The language management control apparatus according to claim 2, wherein the second controller selectively sets in advance the execute instruction to perform the image forming process using the selected second language in a manner such that the image forming process starts from a beginning thereof or at a point thereof where the selected first language is determined to be inadequate after the image forming process is suspended.

11. The language management control apparatus according to claim 3, wherein the second controller selectively sets in advance the execute instruction to perform the image forming process using the selected second language in a manner such that the image forming process starts from a beginning thereof or at a point thereof where the selected first language is determined to be inadequate after the image forming process is suspended.

12. The language management control apparatus according to claim 4, wherein the second controller selectively sets in advance the execute instruction to perform the image forming process using the selected second language in a manner such that the image forming process starts from a beginning thereof or at a point thereof where the selected first language is determined to be inadequate after the image forming process is suspended.

13. The language management control apparatus according to claim 5, wherein the second controller selectively sets in advance the execute instruction to perform the image forming process using the selected second language in a manner such that the image forming process starts from a beginning thereof or at a point thereof where the selected first language is determined to be inadequate after the image forming process is suspended.

14. The language management control apparatus according to claim 6, wherein the second controller selectively sets in advance the execute instruction to perform the image forming process using the selected second language in a manner such that the image forming process starts from a beginning thereof or at a point thereof where the selected first language is determined to be inadequate after the image forming process is suspended.

15. The language management control apparatus according to claim 7, wherein the second controller selectively sets in advance the execute instruction to perform the image forming process using the selected second language in a manner such that the image forming process starts from a beginning thereof or at a point thereof where the selected first language is determined to be inadequate after the image forming process is suspended.

16. The language management control apparatus according to claim 8, wherein the second controller selectively sets in advance the execute instruction to perform the image forming process using the selected second language in a manner such that the image forming process starts from a beginning thereof or at a point thereof where the selected first language is determined to be inadequate after the image forming process is suspended.

17. An image forming apparatus comprising:
the language management control apparatus according to claim 1; and
an image forming unit that forms an image on a recording medium in accordance with the image information.

18. A non-transitory computer readable medium storing a program causing a computer to execute a process for controlling language management, the process comprising:
issuing an execute instruction to perform an image forming process by referencing received image information and by using a first language selected from among a plurality of pre-stored languages;
storing the received image information; and
with the selected first language determined to be inadequate after a start of an execution of the image forming process, issuing a suspend instruction to suspend the image forming process, selecting a second language from a plurality of languages by reading the image information from the memory, and issuing the execute instruction to perform the image forming process.
